(19) United States
(12) Patent Application Publication
(10) Pub. No.: US 2011/0026864 A1
(43) Pub. Date: Feb. 3, 2011

(54) SLIDING MATERIAL, METHOD OF MANUFACTURING SLIDING MATERIAL, AND BEARING APPARATUS USING THE SAME

(75) Inventors: Long Than Trong, Kanagawa-ken (JP); Yuuji Hisazato, Tokyo (JP); Satoshi Namba, Kanagawa-ken (JP); Kazuma Mukai, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba

(21) Appl. No.: 12/934,871

(22) PCT Filed: Mar. 26, 2009
(86) PCT No.: PCT/JP09/56146

§ 371 Date: Sep. 27, 2010

(30) Foreign Application Priority Data
Mar. 27, 2008 (JP) 2008-082917

(51) Int. Cl. F16C 17/04; B32B 27/00; B32B 15/04; B29C 65/14; B32B 27/06; B32B 18/00; D03D 15/00; B32B 3/24; D04H 13/00

(52) U.S. Cl. 384/420; 428/421; 428/457; 156/245; 428/411.1; 428/473.5; 428/446; 442/229; 428/138; 442/377

(57) ABSTRACT

A sliding material includes a sliding surface member, a base member made of a material different from the sliding surface member, a bonding material layer disposed between the sliding surface member and the base member so as to bond the sliding surface member and the base member, and a sheet member made of an electromagnetic induction heating material. The sliding material is manufactured by bonding the sliding surface member and the base member by heating and melting the bonding material layer through electromagnetic induction heating of the sheet member.

### TECHNICAL FIELD

The present invention relates to a sliding material suitably used for a sliding member of a bearing apparatus, a method of manufacturing the sliding material, and a bearing apparatus using the sliding material.

### BACKGROUND ART

Recently, with the advance of industrial technology, it has been required for bearings to be operated at a high speed and to provide a high surface pressure. A sliding material conventionally used for forming a sliding member of a bearing apparatus is a soft metal material, such as white metal (for example, the first type containing 88 to 92 weight percent of Sn, 5 to 7 weight percent of Sb, and 3 to 5 weight percent of Cu). However, such soft metal material has a low melting point and has significant deterioration in strength and seizing at high temperatures, thus being limited in usable and applicable range thereof.

To the contrary, a polytetrafluoroethylene (PTFE) resin material has a low coefficient of friction and a high thermal resistance and is hence suitable as a sliding material for a bearing apparatus. Furthermore, polyether ether ketone (PEEK) resin material and a polyimide (PI) resin material have slightly higher coefficients of friction than the polytetra-fluoroethylene resin material but are superior in high-temperature mechanical characteristics. It is hence possible to manufacture a skidding material that is superior both in mechanical characteristics and friction or wear characteristics by adding various kinds of ceramic fibers or particle filler to these resin materials.

Incidentally, in a case of a bearing particularly supporting a high load, it is desired for a bearing to constitute a sliding surface member with a resin material and a base member with a metal material for bearing high load, and by bonding the these materials to thereby manufacture a sliding material.

However, in bonding the resin material and the metal material to each other, in the conventional technology for bonding different metal materials, sufficient bonding strength could not obtained. For example, if different metal materials are bonded to each other by a melt-and-solidify method, diffusion or the like occurs between the metal materials to produce not only a mechanical bond but also a physical or chemical bond, and thus, a sufficient bonding strength is achieved. However, if a resin material and a metal material are bonded to each other by such melt-and-solidify method, only a mechanical bond occurs, and thus, it is difficult to achieve a sufficient bonding strength. In addition, if the resin material and the metal material are bonded to each other under high-temperature and high-pressure conditions, the resin material may be deteriorated, and in addition, since such conditions have to be maintained for a long time, the manufacturing cost increases, thus having been inconvenient.

According to a proposed technique for bonding a resin material and a metal material of a base member to each other, a porous interlayer is provided on a surface of the metal material of the base member, and the porous interlayer is charged with the resin material to form a layer of the resin material on the metal material of the base member (see Patent Document 1: Japanese Patent Laid-Open No. 10-29256).

However, in this case, the porous interlayer has to be previously bonded to the base member in a vacuum or other non-oxidizing atmosphere. In the case of a large sliding member, such as a bearing for a hydraulic generator, the total weight is several hundred kilograms to several tons, so that the bonding process requiring the non-oxidizing atmosphere is extremely expensive, and in addition, there may cause a case in which the capacity of the vacuum facility becomes insufficient.

According to another conventional technique, a porous molded copper wire is previously impregnated with the resin material, and then, the porous molded copper wire impregnated with the resin material and the metal material are bonded to each other with an Sn-based solder material. More specifically, the porous molded copper wire is partially impregnated with the resin material, and then, with the resin material being disposed on the metal material, the porous molded copper wire partially impregnated with the resin material and the metal material are immersed in a molten Sn-based solder material in a tank to partially impregnate the porous molded copper wire with the Sn-based solder material, thereby bonding the resin material to the metal material.

However, in a case of a large metal sliding member having a weight of several hundred kilograms, such as a bearing for a hydraulic generator, the molten Sn-based solder material solidifies as soon as the solder material comes into contact with the metal material immersed therein because of the high heat capacity of the metal material. Thus, it is extremely difficult to impregnate a gap between the metal material and the resin material and pores in the porous molded copper wire with the solder material. In view of such facts, currently, in manufacture of a large product, an adequate bonding cannot be achieved because a center part of the bonding interface is insufficiently impregnated with the Sn-based solder material.

In order to obviate such matter, for example, the commonly used Sn-based solder material containing 3 weight percent of Ag and 0.5 weight percent of Cu may be molten at a temperature 150 to 200° C. higher than the melting point of 217° C., and the resin material and the metal material to be bonded may be heated to a temperature higher than the temperature at which the solder is molten. However, this approach is subject to a constraint of the melting temperature or thermal decomposition temperature of the resin material. For example, for a polytetrafluoroethylene (PTFE) resin material, at a temperature equal to or higher than 400° C., some of decomposition products react with oxygen to form carbonyl fluoride (COF₂), and COF₂ is hydrolyzed by moisture in the air to produce hydrogen fluoride harmful to the human body and the environment and carbon dioxide gas.

However, even if the temperature can be reduced to below the thermal decomposition temperature of the polytetrafluoro-ethylene (PTFE) resin material, and even if only a small amount of Sn-based solder material is required for bonding, this approach involves the immersing of the resin material and metal material having a weight of several hundred kilograms and therefore requires several hundred kilograms to 1 ton of molten Sn-based solder material. The amount of solder material contains a large amount of Ag, so that this approach is extremely expensive.

In addition, when the metal material and the porous molded copper wire are heated to high temperature, the material surface is oxidized to hinder reaction with the Sn-based solder material, and thus, it is difficult to achieve a sufficient bonding strength. The heating process of the resin material and the metal material and the melting and impregnation process of the Sn-based solder material may be carried out in an inert gas atmosphere. However, this approach requires a large manufacturing facility, and there arises a matter of workability.

### DISCLOSURE OF THE INVENTION

An object of the present invention is to provide a sliding material having a high bonding strength and a high reliability that can be manufactured at low cost by a simple facility with a high workability and a high thermal efficiency by eliminating problems encountered in a conventional sliding material formed by bonding different materials, such as a resin material and a metal material and in a conventional method of manufacturing the sliding material, that is, problems of necessity of entire heating of the resin material and the metal material, production of harmful gas by thermal decomposition and generation of oxidation.

Another object of the present invention is to provide a method of manufacturing the sliding material described above at low cost by a simple facility with a high workability and a high thermal efficiency.

A further object of the present invention is to provide a bearing apparatus using the sliding material manufactured by the manufacturing method described above.

The inventor of the subject application found out, in order to achieve the above objects, that it is extremely effective to dispose a sheet member made of an electromagnetic induction heating material adjacent to a bonding material layer and causing electromagnetic induction heating to the sheet member to melt the bonding material layer, thereby bonding a sliding surface member and a base member to each other.

A sliding material, provided to achieve the above objects, includes:
a sliding surface member;
a base member made of a material different from a material forming the sliding surface member;
a bonding material layer disposed between the sliding surface member and the base member so as to bond the sliding surface member and the base member; and
a sheet member made of an electromagnetic induction heating material disposed in the bonding material layer,
wherein the bonding material layer is molten by electromagnetic induction heating of the sheet member to bond the sliding surface member and the base member to each other.

The above invention provides following preferred embodiments.

It may be preferred that the sliding surface member is made of a polytetrafluoroethylene (PTFE) resin material, a polyether ether ketone (PEEK) resin material, a polyimide (PI) resin material, or a composite material containing any of the resin materials mentioned above and a ceramic fiber or particle as a filler.

The base member may be made of an iron-based, a copper-based or an aluminum-based metal material.

The bonding material layer may be made of Sn, Sn alloy, In, In alloy, Bi or Bi alloy.

The sheet member made of the electromagnetic induction heating material may be embedded in the bonding material layer.

It may be desired that the bonding material layer has a stack structure including a layer of only a bonding material adjacent to the base member and a layer of a mixture of the bonding material and a material forming the sliding surface member.

The sheet member made of the electromagnetic induction heating material may be a porous sheet member.

The sheet member made of the electromagnetic induction heating material may be formed of a sintered body of a powder or short fiber of a ferromagnetic metal material, a fiber woven fabric of a ferromagnetic metal material, or a punched or expanded plate of a ferromagnetic metal material.

The ferromagnetic metal material may be iron or a ferritic stainless steel material.

A method of manufacturing the sliding material for achieving the above object includes the steps of:
preparing an electromagnetic induction heating apparatus provided with a member for supplying a high-frequency current to a magnetic force generating coil and a heating member;
molding a sliding surface member that forms a sliding surface;
placing the sliding surface member on the heating member of the electromagnetic induction heating apparatus;
placing a sheet member made of an electromagnetic induction heating material on the sliding surface member;
placing a bonding material layer on the sheet member;
placing a base member on the bonding material layer; and
causing electromagnetic induction heating of the sheet member made of the electromagnetic induction heating material to melt the bonding material layer and solidifying the bonding material layer to thereby bond the sliding surface member and the base member to each other.

It may be desired that the sheet member made of the electromagnetic induction heating material is embedded in the bonding material layer.

Furthermore, another method of manufacturing the sliding material for achieving the above object includes the steps of:
preparing an electromagnetic induction heating apparatus provided with a member for supplying a high-frequency current to a magnetic force generating coil and a heating member;
molding a sliding surface member that forms a sliding surface;
placing the sliding surface member on the heating member of the electromagnetic induction heating apparatus;
placing a sheet member made of an electromagnetic induction heating material on the sliding surface member;
placing a bonding material layer on the sheet member;
combining and integrating the bonding material layer and the sheet member made of the electromagnetic induction heating material so as to form a composite body;
placing the composite body on the sliding surface member;
placing the base member on the composite body of the bonding material layer and the sheet member made of the electromagnetic induction heating material; and
causing electromagnetic induction heating of the sheet member made of the electromagnetic induction heating material to melt the bonding material layer and solidifying the bonding material layer to thereby bond the sliding surface member and the base member to each other.

It may be desired that the sheet member made of the electromagnetic induction heating material may be embedded in the bonding material layer.

It may be also desired that a portion of the bonding material layer and the sheet member made of the electromagnetic induction heating material are combined and integrated with each other in advance of the electromagnetic induction heating by vapor deposition, plating, coating, thermal spraying, melt impregnation or press molding process.

Still furthermore, according to the present invention, there is provided a bearing apparatus including a thrust bearing that bears a thrust load in an axial direction of a rotating shaft while allowing sliding of the rotating shaft and a guide bearing that supports the rotating shaft so as to suppress an axial runout of the rotating shaft in a rotational direction, wherein the thrust bearing and the guide bearing are formed of the above-mentioned sliding material.

According to the present invention, a sheet member made of an electromagnetic induction heating material is disposed adjacent to a bonding material layer, and a sliding surface member and a base member are bonded to each other by the bonding material layer molten by electromagnetic induction heating of the sheet member to thereby perform local internal induction heating can be achieved. Thus, a reliable sliding member can be provided with a minimum amount of bonding material and a simple manufacturing facility, at extremely low cost, with high workability and without thermal loss.

Furthermore, in the case where the sheet member is a porous sheet having through holes extending the thickness direction thereof, the bonding material in the through holes serves as a kind of wedge and effectively acts against a shear stress acting between the sliding surface member and the base member, thereby remarkably increasing the shear strength.

In addition, the bonding material layer can be selectively heated and molten by controlling the high-frequency power supplied to cause electromagnetic induction heating, so that thermal deterioration of the base member and the sliding surface member can be effectively prevented. Furthermore, as required, the quality of bonding of the bonding material layer may be further improved by heating and melting a surface layer of the sliding surface member and the base member close to the interface with the bonding material layer, in particular, a surface layer of the sliding surface member.

### BRIEF DESCRIPTION OF THE DRAWINGS

FIG. 1 is a schematic cross-sectional view of a sliding material according to an embodiment of the present invention.

FIG. 2 is a schematic cross-sectional view for illustrating a method of manufacturing the sliding material according to the present invention.

FIG. 3 is a partial cross-sectional view of a bearing apparatus according to the present invention formed by using the sliding material.

### BEST MODE FOR CARRYING OUT THE INVENTION

In the following, embodiments of the present invention will be described with reference to the drawings.

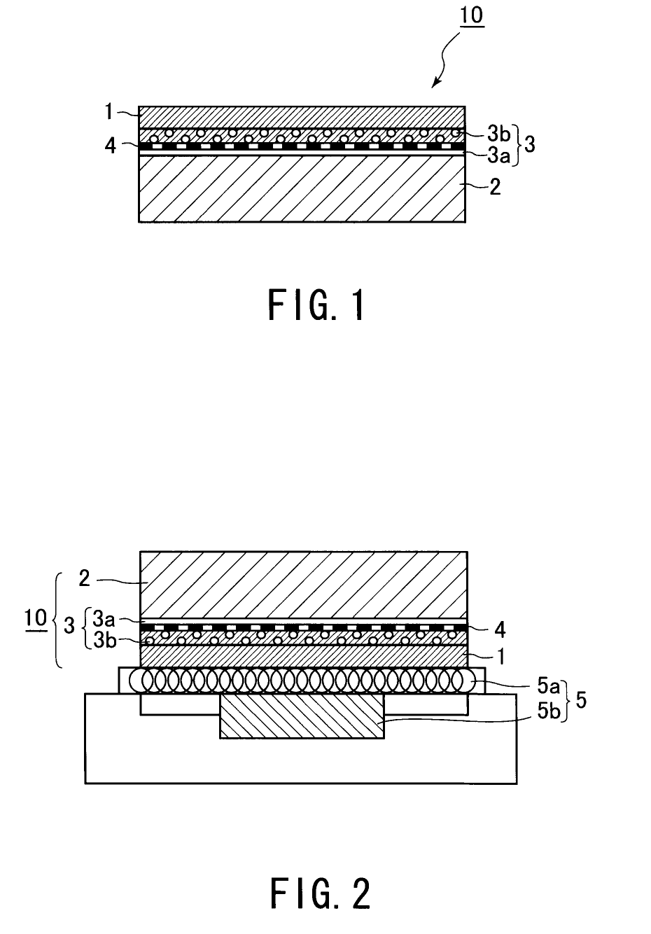

FIG. 1 is a schematic cross-sectional view of a sliding member 10, as viewed in a thickness direction, according to an embodiment of the present invention.

With reference to FIG. 1, the sliding member 10 is composed of a sliding surface member (a member forming a sliding surface of the sliding member 10) 1, a base member 2 made of a different material from the sliding surface member 1, and a bonding material layer 3 disposed between the sliding surface member 1 and the base member 2 to bond the sliding surface member and the base member to each other.

A sheet member 4 made of an electromagnetic induction heating material is embedded in the bonding material layer 3, and the bonding material layer 3 is molten by electromagnetic induction heating by the sheet member 4, thereby bonding the sliding surface member 1 and the base member 2 to each other.

The sliding surface member 1 is made of polytetrafluoro-ethylene (PTFE) resin material, polyether ether ketone (PEEK) resin material, polyimide (PI) resin material, or composite material made by adding ceramic fiber or particle as a filler to any of these resin materials. The polytetrafluoroethylene resin material has a low coefficient of friction and a high heat resistance. The polyether ether ketone resin material and the polyimide resin material have coefficients of friction slightly higher than the polytetrafluoroethylene resin material but are superior in high-temperature mechanical characteristics. The composite materials described above are superior both in friction or wear characteristics and in mechanical characteristics. The thickness of the sliding surface member 1 depends on the required durability of the sliding member 1, and typically, is about 1 to 5 mm.

The base member 2 is a structural member that provides a strength enough to bear a high load applied to the sliding member 10. The base member 2 is made of any material that can provide a required strength under use conditions thereof, such as an iron-based metal material, a copper-based metal material, and an aluminum-based metal material for general purpose use. In particular, a steel material, such as a structural carbon steel (S45C), is preferable.

The bonding material layer 3 bonds the sliding surface member 1 and the base member 2 together, and as the bonding material, a Sn-based solder material, a Sn-based lead-free solder material, an In-based solder material or a Bi-based solder material for general purpose use may be utilized. According to the electromagnetic induction heating of the sheet member 4 embedded in the bonding material layer 3, the bonding material layer 3 and, if necessary, the surface layer of the sliding surface member 1 and the base member 2 adjacent to the bonding material layer 3, can be selectively heated. Therefore, the bonding material layer 3 is less affected by the melting point or the like of the sliding surface member 1 and the base member 2.

Generally, the bonding material layer 3 has a thickness of about 1 to 10 mm, and in this embodiment, the bonding material layer 3 has a stack structure composed of a layer 3a made of only the bonding material adjacent to the base member 2 and a layer 3b made of a mixture of the bonding material and the material of the sliding surface member 1. According to the adoption of such stack structure, the strength of the bonding between the resin-based sliding surface member 1 and the bonding material layer 3 can be improved.

It is preferred that the sheet member 4 made of an electromagnetic induction heating material disposed adjacent to the bonding material layer 3 is made from a porous sheet, and specifically, the sheet member 4 is preferably formed by a sintered body of a powder or short fiber of a ferromagnetic metal material, a fiber woven fabric of a ferromagnetic metal material, or a punched or expanded plate of a ferromagnetic metal material.

In terms of the thermal efficiency of electromagnetic induction heating, a ferromagnetic material or a metal material having a high electric resistance is preferable. However, since the calorific value can be increased by increasing the electric current, a material having a low electric resistance, such as copper and aluminum, may also be used. In particular, the sheet member 4 is preferably made of iron or a ferritic stainless steel material and has a permeability of 100 to 500.

It is preferred, from the viewpoint of increasing the bonding area with the bonding material and improving the thermal efficiency, that the sheet member 4 made of the electromagnetic induction heating material is formed of a porous sheet. However, the sheet member may also be formed of a plate of a bulk material, a composite of different kinds of materials, or a clad material. In general, the thickness of the sheet member 4 is about 0.1 to 5 mm, and the sheet member 4 is preferably embedded in the bonding material layer 3 and disposed between the sliding surface member 1 and the base member 2. Although the pores of the porous sheet member may have any dimensions, it may be desired that the pore has a diameter of about 0.1 to 10 μm, which allows invasion of the bonding material.

Hereunder, a method of manufacturing the sliding member according to the present invention described above will be explained.

As described hereinabove, the method of manufacturing the sliding member according to the present invention includes a molding step of molding the sliding surface member, a placing step of placing the sliding surface member on a heating portion of an electromagnetic induction heating apparatus provided with a device that supplies a high-frequency electric current to a magnetic force generating coil, a placing step of placing the sheet member made of the electromagnetic induction heating material on the sliding surface member, a placing step of placing the bonding material on the sheet member made of the electromagnetic induction heating material, a placing step of placing the base member on the bonding material, and a bonding step of bonding the sliding surface member and the base member to each other by causing electromagnetic induction heating by the sheet member made of the electromagnetic induction heating material to thereby melt the bonding material and then letting the bonding material solidify. Further, it is to be noted that it is not necessary to separately performing these steps and some of these steps may be carried out at the same time.

The bonding material is disposed adjacent to the sheet member made of the electromagnetic induction heating material. Alternatively, a sheet or powder of the bonding material may be disposed on either or both sides of an electromagnetic induction heating member, and the bonding material and the electromagnetic induction heating member may be press-molded to form a clad. When the powder material is used, the sliding surface member is combined with the two materials so as to simplify the subsequent process. Alternatively, the bonding material layer and the sheet member made of the electromagnetic induction heating material may be previously combined with each other by performing plating, coating, thermal spraying, melt impregnation or press molding process to thereby simplify the subsequent process.

In a preferred embodiment, the sliding material 10 shown in FIG. 1 may be manufactured by a system shown in the schematic cross-sectional view of FIG. 2. Referring to FIG. 2, according to this embodiment, a powder material of the sliding surface member 1, a material of the layer 3b made of a mixture of the powder material and a powder bonding material, and the sheet member 4 made of the electromagnetic induction heating material are press-molded to thereby form an integral composite member or body. Then, the composite body is placed on an electromagnetic induction heating apparatus 5 having an electromagnetic induction heating coil 5a and an electromagnetic induction heating power supply 5b, and a layer 3a of a sheet or powder of the bonding material and the base member 2 are placed on the composite body. Thereafter, the electromagnetic induction heating apparatus 5 is activated to cause electromagnetic induction heating by the sheet member 4 to heat and melt the bonding material layer 3 including the layers 3a and 3b, and the bonding material layer 3 is then solidified to thereby bond the base member 2 and the sliding surface member 1 to each other.

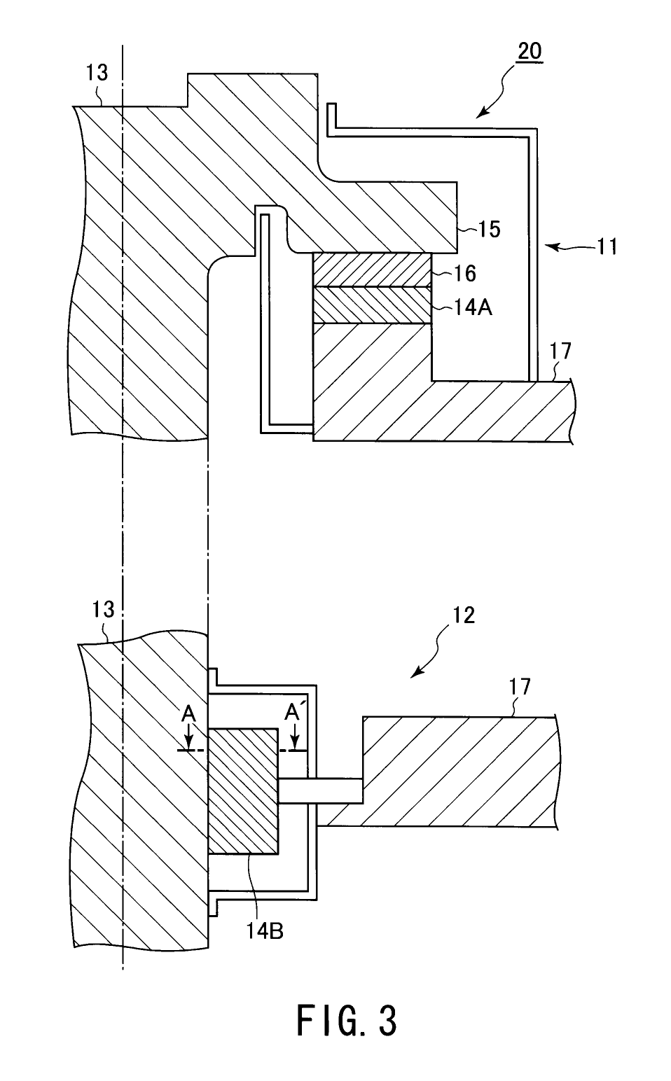

FIG. 3 is a partially cross-sectional view of an example of the bearing apparatus according to the present invention produced by the manner described above. FIG. 3 shows an example in which a bearing apparatus 20 is applied to a water wheel generator, and a thrust bearing device 11 and a guide bearing device (referred to also as a journal bearing device) 12 supports a rotating shaft 13.

The thrust bearing device 11 is composed of a plurality of sliding members 14A radially arranged around the rotating shaft 13. As shown in FIG. 3, the thrust bearing device 11 bears a thrust load in the axial direction of the rotating shaft 13 applied to the sliding members 14A via a thrust collar 15, a thrust runner 16 and the like fixed to the rotating shaft 13, the thrust load, for example, being a sum of the weight of the rotating shaft 13 and the like and a hydraulic thrust applied to the water wheel during operation, in such a manner that the rotating shaft 13 can slide with respect to the thrust bearing device 11 by the sliding member 14A.

The guide bearing device 12 includes a plurality of sliding members 14B cylindrically arranged around the rotating shaft 13 in slidable contact with the rotating shaft 13. The guide bearing device 12 slidably supports the rotating shaft 13 at the sliding members 14B so as to suppress an axial runout of the rotating shaft in the rotational direction. The sliding members 14B may be segments of the guide bearing device 12 divided into two or eight segments, for example. The thrust bearing device 11 and the guide bearing device 12 are each supported by a supporting member 17.

According to the present invention, the sliding members 14A and 14B described above are formed by the sliding material 10 shown in FIG. 1.

### EXAMPLE

Hereunder, a specific example of the present invention will be described.

### Example 1

The sliding material 10 according to the present invention was manufactured by using the apparatus arranged as shown in FIG. 2. Specifically, first, a polytetrafluoroethylene (PTFE) resin material powder (having an average grain size of about 35 μm and a melting point of about 327° C.), which is a material of the sliding surface member 1, was introduced into a mold having a rectangular opening having a size of 300 mm by 300 mm in an amount to provide a resulting sliding surface member 1 having a thickness of 3 mm. Then, a powder mixture of the same polytetrafluoroethylene (PTFE) resin material powder and an Sn powder containing 0.7 weight percent of Cu serving as a bonding material (having an average grain size of about 50 μm and a melting point of about 227° C.) mixed in a volume ratio of one to one, which is a material of the layer 3b, was introduced into the mold in an amount to provide a resulting layer 3b having a thickness of 1 mm. Then, a pure iron 20—mesh plain—weave wire mesh (net) having planar dimensions of 300 mm by 300 mm and a wire diameter of 0.3 mm serving as the porous sheet material made of the electromagnetic induction heating material was placed on the powder mixture, and then, the resulting stack was press-molded under a pressure of 50 MPa. Thereafter, the press-molded stack was heated to 375° C. for one hour to melt the PTFE resin, thereby producing the composite of the sliding surface member 1, the bonding material layer 3b and the electromagnetic induction heating porous sheet material 4.

Then, the composite of the sliding surface member 1, the bonding material layer 3b and the electromagnetic induction heating porous sheet material 4 was placed on the electromagnetic induction heating apparatus 5 having the electromagnetic induction heating coil 5a and the electromagnetic induction heating power supply 5b, and a sheet of a Sn-based bonding material 3a containing 0.7 weight percent of Cu having a thickness of 0.2 mm, a width of 300 mm and a length of 300 mm was placed on the composite.

Then, a iron base member 2 having a thickness of 50 mm, a width of 300 mm and a length of 300 mm was placed on the bonding material sheet 3a, and then, the electromagnetic induction heating member 4 was heated by the electromagnetic induction heating apparatus 5 so as to melt the bonding material members 3a and 3b. Then, the bonding material members 3a and 3b were solidified so as to bond the sliding surface member 1 and the base member 2 to each other.

Evaluation of the shear strength of the bonding interface of the sliding material showed that the shear strength was about 20 MPa, which is sufficient for the sliding material.

### INDUSTRIAL APPLICABILITY

As described above, the present invention provides a sliding material having a high bonding strength and a high reliability that can be manufactured at low cost by a simple facility with a high workability and a high thermal efficiency and obviate inconveniencies in a conventional sliding material formed by bonding different materials, such as a resin material and a metal material and in a conventional method of manufacturing the sliding material that the whole of the resin material and the metal material has to be heated, a harmful gas is produced by thermal decomposition, and oxidation occurs, and also provides a method of manufacturing the sliding material and a bearing apparatus using the sliding material.

1. A sliding material comprising:
a sliding surface member;
a base member made of a material different from a material forming the sliding surface member;
a bonding material layer disposed between the sliding surface member and the base member so as to bond the sliding surface member and the base member; and
a sheet member made of an electromagnetic induction heating material disposed in the bonding material layer,
wherein the bonding material layer is molten by electromagnetic induction heating of the sheet member to bond the sliding surface member and the base member to each other.

2. The sliding material according to claim 1, wherein the sliding surface member is made of a polytetrafluoroethylene (PTFE) resin material, a polyether ether ketone (PEEK) resin material, a polyimide (PI) resin material, or a composite material containing any of the resin materials mentioned above and a ceramic fiber or particle as a filler.

3. The sliding material according to claim 1, wherein the base member is made of an iron-based, a copper-based or an aluminum-based metal material.

4. The sliding material according to claim 1, wherein the bonding material layer is made of Sn, Sn alloy, In, In alloy, Bi or Bi alloy.

5. The sliding material according to claim 1, wherein the sheet member made of the electromagnetic induction heating material is embedded in the bonding material layer.

6. The sliding material according to claim 5, wherein the bonding material layer has a stack structure including a layer of only a bonding material adjacent to the base member and a layer of a mixture of the bonding material and a material forming the sliding surface member.

7. The sliding material according to claim 1, wherein the sheet member made of the electromagnetic induction heating material is a porous sheet member.

8. The sliding material according to claim 1, wherein the sheet member made of the electromagnetic induction heating material is formed of a sintered body of a powder or short fiber of a ferromagnetic metal material, a fiber woven fabric of a ferromagnetic metal material, or a punched or expanded plate of a ferromagnetic metal material.

9. The sliding material according to claim 8, wherein the ferromagnetic metal material is iron or a ferritic stainless steel material.

10. A method of manufacturing a sliding material according to claim 1, comprising:
preparing an electromagnetic induction heating apparatus provided with a member for supplying a high-frequency current to a magnetic force generating coil and a heating member;
molding a sliding surface member that forms a sliding surface;
placing the sliding surface member on the heating member of the electromagnetic induction heating apparatus;
placing a sheet member made of an electromagnetic induction heating material on the sliding surface member;
placing a bonding material layer on the sheet member;
placing a base member on the bonding material layer; and
causing electromagnetic induction heating of the sheet member made of the electromagnetic induction heating material to melt the bonding material layer and solidifying the bonding material layer to thereby bond the sliding surface member and the base member to each other.

11. The method of manufacturing a sliding material according to claim 10, wherein the sheet member made of the electromagnetic induction heating material is embedded in the bonding material layer.

12. A method of manufacturing a sliding material according to claim 1, comprising:
preparing an electromagnetic induction heating apparatus provided with a member for supplying a high-frequency current to a magnetic force generating coil and a heating member;
molding a sliding surface member that forms a sliding surface;
placing the sliding surface member on the heating member of the electromagnetic induction heating apparatus;
placing a sheet member made of an electromagnetic induction heating material on the sliding surface member;
placing a bonding material layer on the sheet member;
combining and integrating the bonding material layer and the sheet member made of the electromagnetic induction heating material so as to form a composite body;
placing the composite body on the sliding surface member;
placing the base member on the composite body of the bonding material layer and the sheet member made of the electromagnetic induction heating material; and
causing electromagnetic induction heating of the sheet member made of the electromagnetic induction heating material to melt the bonding material layer and solidifying the bonding material layer to thereby bond the sliding surface member and the base member to each other.

13. The method of manufacturing a sliding material according to claim 12, wherein the sheet member made of the electromagnetic induction heating material is embedded in the bonding material layer.

14. The method of manufacturing a sliding material according to claim 12, wherein a portion of the bonding material layer and the sheet member made of the electromagnetic induction heating material are combined and integrated with each other in advance of the electromagnetic induction heating by vapor deposition, plating, coating, thermal spraying, melt impregnation or press molding process.

15. A bearing apparatus comprising a thrust bearing that bears a thrust load in an axial direction of a rotating shaft while allowing sliding of the rotating shaft and a guide bearing that supports the rotating shaft so as to suppress an axial runout of the rotating shaft in a rotational direction, wherein the thrust bearing and the guide bearing are formed of a sliding material according to claim 1.
